(19) United States
(12) Patent Application Publication
(10) Pub. No.: US 2024/0386266 A1
(43) Pub. Date: Nov. 21, 2024

(54) STRUCTURE LEARNING IN GNNS FOR MEDICAL DECISION MAKING USING TASK-RELEVANT GRAPH REFINEMENT

(71) Applicant: NEC Laboratories America, Inc., Princeton, NJ (US)

(72) Inventors: Jonathan Warrell, Princeton, NJ (US); Eric Cosatto, Red Bank, NJ (US); Renqiang Min, Princeton, NJ (US); Tianci Song, Eagan, MN (US)

(21) Appl. No.: 18/666,088

(22) Filed: May 16, 2024

Related U.S. Application Data
(60) Provisional application No. 63/622,152, filed on Jan. 18, 2024.
(60) Provisional application No. 63/466,986, filed on May 16, 2023.
(60) Provisional application No. 63/550,306, filed on Feb. 6, 2024.

(51) Int. Cl. G06N 3/08

(52) U.S. Cl. CPC G06N 3/08

(57) ABSTRACT

A method for graph analysis includes identifying trainable control parameters of a graph refinement function. Sample graph refinements of an input graph are generated, using control parameters sampled from a variational distribution. Graph refinement control parameters associated with a sample graph refinement that has a highest performance score are selected when used to train a graph neural network. Graph analysis is performed on the input graph using the selected graph refinement parameters to produce a refined graph on new test samples. An action is performed responsive to the graph analysis.

### RELATED APPLICATION INFORMATION

This application claims priority to U.S. Patent Application No. 63/466,986, filed on May 16, 2023, to U.S. Patent Application No. 63/622,152, filed on Jan. 18, 2024,and to U.S. Patent Application No. 63/550,306, filed Feb. 6, 2024, incorporated herein by reference in its entirety.

### BACKGROUND

### Technical Field

The present invention relates to machine learning and, more particularly, to structure learning in graph neural networks.

### Description of the Related Art

Graph neural networks (GNNs) may be used to model systems whose components interact in a structured way. For instance, neighboring cells in a tissue determine which genes are expressed in each spatial location, and bonds between atoms in a protein molecule determine the conformations the protein may take. However, the performance of a GNN model is strongly determined by the underlying graph selected; if irrelevant edges are present between components which do not interact, or edges are missing between components which do, the model will underperform. In predicting spatial gene expression for instance, cells which are close with similar morphology may be expected to share similar expression patterns, but not those with differing morphologies. Similarly, in a three-dimensional graph, a length scale may be selected to determine which nodes in a protein's structure are close enough to one another to interact, but a given choice of length scale may introduce irrelevant connections between non-interacting regions.

### SUMMARY

A method for graph analysis includes identifying trainable control parameters of a graph refinement function. Sample graph refinements of an input graph are generated, using control parameters sampled from a variational distribution. Graph refinement control parameters associated with a sample graph refinement that has a highest performance score are selected when used to train a graph neural network. Graph analysis is performed on the input graph using the selected graph refinement parameters to produce a refined graph on new test samples. An action is performed responsive to the graph analysis.

A system for graph analysis includes a hardware processor and a memory that stores a computer program. When executed by the hardware processor, the computer program causes the hardware processor to identify trainable control parameters of a graph refinement function, to generate sample graph refinements of an input graph, using control parameters sampled from a variational distribution, to select graph refinement control parameters associated with a sample of the plurality of sample graph refinements that has a highest performance score when used to train a graph neural network, to perform graph analysis on the input graph using the selected graph refinement parameters to produce a refined graph on new test samples, and to perform an action responsive to the graph analysis.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of a method for graph analysis applied in the context of spatial transcriptomics prediction from Hematoxylin and eosin stained images, in accordance with an embodiment of the present invention;

FIG. 2 is pseudo-code for performing smoothing-based optimization, in accordance with an embodiment of the present invention;

FIG. 3 is a block/flow diagram of a method for smoothing-based optimization, in accordance with an embodiment of the present invention;

FIG. 4 is a block/flow diagram of a method of training and using a graph neural network, in accordance with an embodiment of the present invention;

FIG. 5 is a block diagram of a healthcare facility that makes use of protein graph analysis for medical decision making, in accordance with an embodiment of the present invention;

FIG. 6 is a block diagram of a computing device that trains and uses a graph neural network, in accordance with an embodiment of the present invention;

FIG. 7 is a diagram of an exemplary neural network architecture that can be used in a graph analysis model, in accordance with an embodiment of the present invention; and

FIG. 8 is a diagram of an exemplary deep neural network architecture that can be used in a graph analysis model, in accordance with an embodiment of the present invention.

### DETAILED DESCRIPTION OF PREFERRED EMBODIMENTS

The graph structure may be learned jointly with graph representations for a specific target system. A graph neural network (GNN) model may be combined with trainable control parameters that determine the graph structure of the model. These control parameters are combined with fixed graph-based features as input to an arbitrary graph refinement function to determine the graph structure of the GNN. This allows the graph structure to be trained implicitly by finding the graph refinement parameters leading to the best predictions.

An objective may be used to train the model that includes differentiable and non-differentiable parts. Variational optimization may be used to optimize a smoothed objective function globally, while enhancing the model locally via local gradients within differentiable regions of the parameter space. A variational bound specifies global features of the graphs to search over. While a particular graph refinement approach is described herein to handle prediction of spatial transcriptomics from Hematoxylin and eosin images, the same approach is generalizable in that the same bound can be used to search over arbitrary sets of graphs.

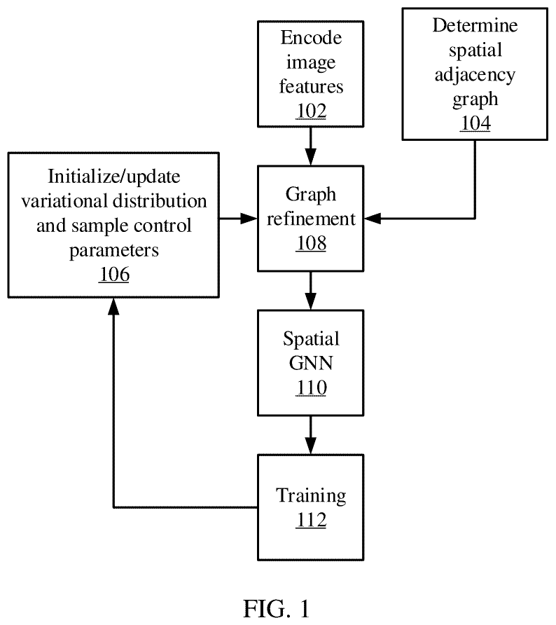

Referring now to FIG. 1, an adaptive spatial GNN architecture is shown. A tissue sample is provided as input, with block 102 encoding image features using, e.g., an encoder neural network model, and with block 104 extracting a spatial adjacency graph G. The distribution over the control parameters 106 for the graph refinement function are initialized using a normal distribution. The control parameters are used by a graph refinement function 108 to generate a set of refined spatial graphs, which are applied as inputs to a spatial GNN 110.

The spatial GNN 110 may be implemented as a graph transformer network that includes a set of GNN layers, an embedding layer, and a linear layer to create, for example, a gene expression prediction Y. Each prediction is evaluated by training 112 to determine a respective score, which is used to update the distribution over the control parameters 106.

In some examples, the input graph may represent a histological image, with nodes in the graph corresponding to capturing spots for which spatial transcriptomics data is available. The image may be represented as a graph structure of the form G={X, E}, with a preliminary set of edges E⊂N×N, where N is the set of nodes and X denotes the matrix of D-dimensional image features associated with the N nodes in the graph. Hence, for a node i, an associated feature vector may be defined as xᵢ ∈ [symbol] ^{D}. In addition, for each node i, there is an associated output vector yᵢ ∈ [symbol] ^{D}^{_{Y}}, representing he expression levels of D_{Y} genes associated with capturing spot i.

In some embodiments, spatial transcriptomics may establish a connection between spatial gene expression profiles and histological images based on existing spatial transcriptomics datasets. Gene expression of a capturing spot can be predicted with the corresponding image patch from a stained image. For example, hematoxylin and eosin (H&E) or immunofluorescence stained images may be used as the input image. Image patches may be extracted from spots in the input image arranged in an eight-connected spatial graph. The eight-connected spatial graph may be used as the initial spatial adjacency graph, with refinement being used to remove edges. The image features may be determined for each respective spot.

To allow for the accentuation of domain-restricted information, the graph refinement function may preferentially preserve edges between nodes with similar image features. Such a model achieves better predictive performance and is also highly interpretable, providing useful biological insights. The model may also be applied to other graph-based predictive tasks with minimal adaptation.

A machine learning architecture may be determined using L layers, in a system with an appropriate type of message-passing, such as GCNConv or TransformerConv message-passing. The node feature vector xₙ^{l} ∈ [symbol] ^{D}^{ₜ} is the node feature vector of node n in layer l with dimensionality Dₜ, while W^{l} is the layer-specific trainable weight matrix. It is assumed that a further set of trainable control parameters ϕ ∈ [symbol] ^{D}^{_{ϕ}} are available as input to a graph refinement function [symbol] which returns a refined graph G′= [symbol] (G, ϕ) using the current control parameters ϕ.

The refined graphs can be used to predict spatial gene expression matrices as output using multivariate graph regression. The network may output the predicted matrix by performing message passing on the refined graphs G′ᵢ. The network may be parameterized by weight matrices W_{1 . . . L}, where L is the number of layers in the GNN, with Wₗ having dimensionality Dₗ₋₁×Dₗ, such that Dₗ is the number of hidden units per node in layer l and D₀=D_{X}, with D_{L}=D_{Y}. Additional hyperparameters may be set as {L, D_{1 . . . L-1}}. The full model may be expressed as:

$${x}_{n}^{l} = σ ( {\sum }_{\{ m \vert ( m , n ) ∈ {G}^{′} \}} \frac{{x}_{m}^{l - 1} {W}_{l}}{\sqrt{deg ( n ) deg ( m )}} )$$

for levels l<L, where σ(x)=max (0, x) is the rectified linear unit (ReLU) function and deg (·) is the degree of a node. For level L, a final linear layer may be used, applied to each node independently. Hence, xₙ^{L}=xₙ^{L-1}W_{L}. For a training loss:

$$ℒ ( 𝒳 , 𝒴 \vert {W}_{0 … L} ) = {\sum }_{i} {ℒ}_{i} ( {G}_{i} , {Y}_{i} \vert {W}_{1 … L} ) \\ {ℒ}_{i} ( {G}_{i} , {Y}_{i} \vert {W}_{1 … L} ) = {\sum }_{i} MSE ( {X}_{i}^{L} , {Y}_{i} ) - λ {\sum }_{j = 1 … {D}_{Y}} PCC ( {x}_{ij}^{L} , {y}_{ij} )$$

where [symbol] ={Gᵢ=(Xᵢ, Eᵢ|i=1 . . . . N)}, Gᵢ is the image graph for the i^{th} data point (e.g., a whole slide image), with Xᵢ being the matrix of node features for data point i, and Eᵢ being the edge set for the spatial connectivity of graph Gᵢ. The term [symbol] is the predicted output spatial gene expression data {Yᵢ|i=1 . . . N}, where Yᵢ is the expression matrix for the image i, having dimensionality Nᵢ×D_{Y}. D_{Y} is the number of predicted genes. MSE (X, Y) is the mean squared error between matrices X and Y, summed across all elements, PCC (x, y) is the Pearson correlation coefficient between vectors x and y, each being a vector of expression values across the nodes of the final layer, and λ is a trade-off parameter, which may be set to zero to consider the MSE loss only.

An example of the graph refinement function [symbol] may be a distance-based drop-out function. A distance function may be defined on the nodes of graph i as:

d(n₁, n₂)=Euclidean (zₙ_{₁}, zₙ_{₂})

where zₙ ∈ [symbol] ^{D}^{_{Z}} is a linear projection of the image features associated with node n (e.g., the n^{th} row of Zᵢ=X₀ϕₚᵣₒⱼ), and Euclidean [symbol] is the Euclidean distance between vectors. The connectivity of G′ᵢ may be established by applying a fixed threshold τ to the edges of Gᵢ to generate [symbol] ((X₀, E), ϕ)=(X₀, E^{l}), where E′ᵢ={(n₁, n₂)|(n₁, n₂) ∈ Eᵢ, d (n₁, n₂)≤τ} and ϕ={ϕₚᵣₒⱼ, τ}, and ϕₚᵣₒⱼ is a real-valued matrix of size D_{X}×D_{Z}.

It should be understood that other graph refinement functions may be used instead. Other appropriate functions include a k-nearest-neighbors function, where edges are removed from the original graph which are not within the k-nearest-neighbor graph constructed from Zᵢ as described above. Tissue compartment prediction functions may also be used, which may be trained to predict known annotations (e.g., tumor vs stroma regions) and a separate threshold τ₍ᵣ_{₁}_{, r}_{₂}) for each pair of regions (r₁, r₂). The control parameters of [symbol] may be any real-valued parameters.

A dataset [symbol] includes pairs (G, Y) of matching graphs and labels. During training, the log-probability of the dataset [symbol] may be optimized: F (θ)= [symbol] log P (Y|G, θ), where θ={W^{1. . . L}, ϕ}. Since F includes discontinuities due to the graph refinement function [symbol] , a variational distribution may be used:

Q(θ)= [symbol] (θ|μ, σ²I)

where μ is a mean, σ is a standard deviation, I is the identity matrix, [symbol] (·|Σ) is a multivariate Gaussian distribution, and an associated smoothed variational objective is used:

[symbol]

ᵢ^{smooth}(μ, σ)= [symbol] _{Q}[F(θ)]

F(·) may represent the total log-likelihood of the data, while [symbol] _{Q} is the expectation over the variational distribution [symbol] .

By optimizing [symbol] ᵢ^{smooth}, a lower bound on the whole objective function [symbol] is optimized, as

$${𝔼}_{Q} [ F ( θ ) ] \leq {max}_{θ} F ( θ ) .$$

As F is continuous within local regions (e.g., for fixed ϕ), the smoothing objective can be strengthened using local optimization. For an effective local optimizer [symbol] , for which [symbol] (θ)=θ′ such that F (θ′)≥F(θ), an augmented variational objective may be defined as:

[symbol]

ᵢ^{aug}(μ, σ)= [symbol] _{Q} [F′(θ)], F′(θ=F( [symbol] (θ))

which provides a tighter bound on the original loss, since:

$${𝔼}_{Q} [ F ( θ ) ] \leq {𝔼}_{Q} [ {F}^{′} ( θ ) ] \leq {max}_{θ} F ( θ )$$

Smoothing-based optimization may be used to optimize [symbol] ᵢ^{aug}, combined with local gradient descent. The variational distribution may be determined by parameters {μₜ, σₜ} at t=0. Samples θ_{s=1 . . . N}_{_{S}} may be drawn from the variational distribution, for example implemented as a Gaussian distribution [symbol] (·|μₜ, σₜ²I). In an exemplary embodiment, there may be fifteen samples per meta-epoch. The local gradient descent optimizer [symbol] may be used on each sample to fix the control parameters while optimizing the layers of the GNN, generating θ′_{s=1 . . . N}_{_{S}}. A value for a sample s may be calculated as fₛ=max (F′(θₛ)+c, 0)=max (F(θ′ₛ)+c, 0, where c is an offset to ensure that fₛ is non-negative. The value fₛ is the same as the sample score, but shifted to ensure that it is positive. The terms μₜ₊₁ and σₜ₊₁ may be updated using this value as:

$${μ}_{t + 1} = \frac{{Σ}_{s} {f}_{s} {θ}_{s}^{t}}{{σ}_{s} {f}_{s}} \\ {σ}_{t + 1} = \sqrt{\frac{{Σ}_{s} {f}_{s} {\vert {θ}_{s}^{t} - {μ}_{t} \vert}_{2}^{2}}{{N}_{S} {Σ}_{s} {f}_{s}}}$$

Although these updates may be applied simultaneously, they may alternatively be applied sequentially to improve convergence to a local optimum. The distribution Q may be restricted to the parameters ϕ, which is equivalent to setting μᵢ=0 to all other parameters. Two separate deviations, σₐ and σ_{b} may be used for ϕ and all other parameters respectively, where only σₐ is updated as described above, while σ_{b} remains fixed at σ_{b}=1. In such an embodiment, all other parameters may be initialized using a standard normal distribution.

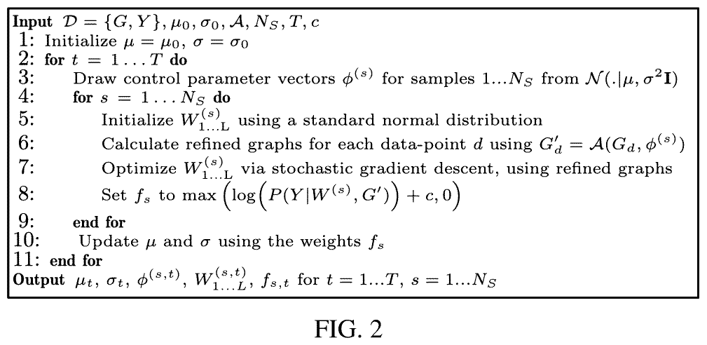

Referring now to FIG. 2, pseudo-code for smoothing-based optimization, optimized with local gradients, is shown. A loop processes sets values of the parameters for the Ns different samples, iteratively updating the values of μ and σ. T represents the number of meta-epochs. At each step, stochastic gradient descent is used to optimize the parameters. The best score F′(θ′ₛ) may be determined during testing across all meta-epochs.

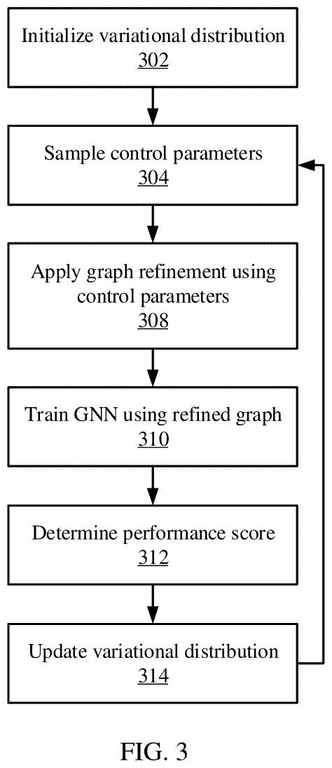

Referring now to FIG. 3, a method of performing graph structure selection in the context of a GNN task is shown. Each image in a dataset is encoded by a respective graph [symbol] ={X, E}, where each node i is represented by a feature vector xᵢ ∈ X. Block 302 initializes the variational distribution Q (θ) to a normal distribution and block 304 samples the control parameters from this distribution.

Block 308 applies a graph refinement function on each graph, generating sub-graphs, for example using the thresholded distance function, described above, to generate the refined edge set E′, resulting in a refined graph [symbol] ′={X, E′}. In some examples, block 310 trains a GNN using the fractionalized graphs [symbol] ′, with a negative cross-entropy loss serving as the performance score for each ϕ sample, corresponding to respective graph partitions. In other examples, block 310 performs training using the MSE+PCC loss described above, which may be used during back-propagation for stochastic gradient descent.

Performance scores for the different refinements of the graph are determined 312 by this training and are used by block 314 to update the variational distribution Q (θ) via smoothing-based optimization, for example as described with respect to FIG. 2 above. Steps 304-314 may be repeated until the score across the variational distribution Q (θ) converges or until a predetermined maximum number of iterations has been reached. The expected score across Q (θ) increases in expectation and is bounded by the optimal log-likelihood value: 0. As noted above, the variational distribution depends on the parameters μ and σ, which are updated by the smoothing-based optimization.

When performing prediction on new samples, the graph refinement control parameters may be determined using the best performing control parameters across all epochs and samples during training. Graph refinement is applied to derive a new graph G′, which is then used for prediction.

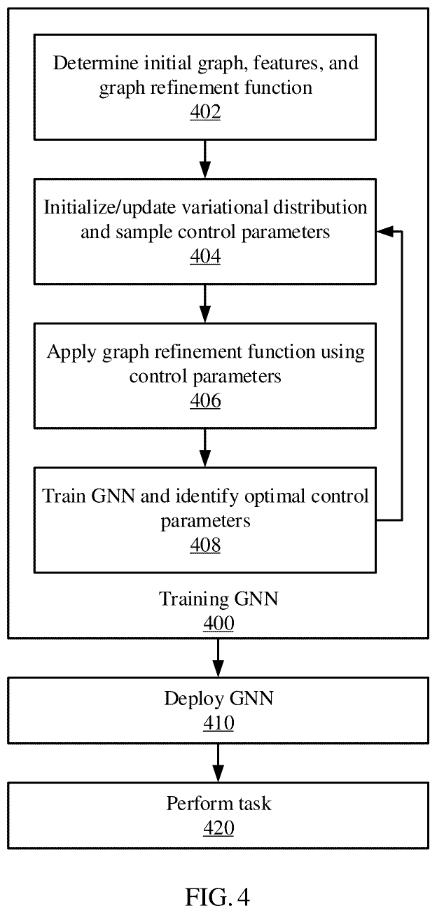

Referring now to FIG. 4, a method of training a GNN is shown. Block 400 trains a GNN to perform a particular task. After training, block 410 deploys the GNN to a target system and block 420 performs a task using the GNN, for example applying novel inputs to determine an appropriate response. New input graphs are partitioned by block 420 in the manner described above to provide a graph structure selection for a diagnosis task. The task 420 can be any appropriate graph-based task, for example including predicting spatial transcriptomics data from Hematoxylin and eosin stained images. In some examples, the task may be to diagnose whether a given tissue sample represents HER2-positive tumor tissue relating to breast cancer.

During training 400, block 402 determines the initial graph (e.g., receiving such a graph as input), features of the graph, and a graph refinement function. Block 404 then initializes the distribution over the graph refinement control parameters, for example to a normal distribution. Block 406 applies the graph refinement function using the trained control parameters and block 408 trains a GNN model and updates the latent features.

For example, the trained model may be used to predict spatially resolved gene expression via tissue morphology in hematoxylin and eosin (H&E) stained images, with an adaptive spatial graph. Estimation of spatial gene expression helps to decode the tissue complexity in a spatial context, such as in a tumor microenvironment or in embryonic development. Thus, the task may include a regression task of predicting he spatial expression of targeted genes. Based on the result of this task, a treatment may be automatically administered to a patient.

The control parameters may be sampled to transform image features, extracted from the stained tissue images, into latent feature vectors. The latent features may be used to generate spatial graphs by removing irrelevant edges as those whose Euclidean distance is below a threshold as above. The GNN model with image features is trained on the refined graphs to predict gene expression, where the spatial information is only shared on edges in the refined graph. Weights for the linear layers are drawn from a multivariant Gaussian distribution, with a variational approximation that maximizes a score function defined by the training errors of the predicted spatial gene expression. Other applications include the identification of novel biomarkers for patient stratification by augmenting ground-truth spatial sequencing data with predicted expressions, and prediction of tumor genetic sub-types to select patients for genetic sequencing based on the predicted presence of high-risk genetic variants.

The GNN model may be any appropriate machine learning architecture, with examples including convolutional and transformer-based GNN architectures.

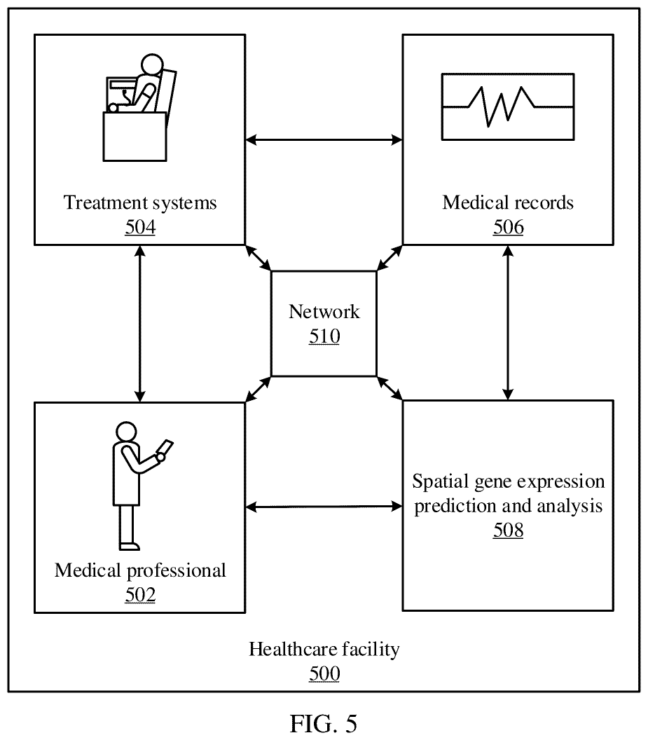

Referring now to FIG. 5, a diagram of information extraction is shown in the context of a healthcare facility 500. Spatial gene expression prediction and analysis 508 may be used to process information relating to genes taken from a patient's tissue sample. The spatial gene expression prediction and analysis 508 may use graph structure selection as described above to improve the quality of outputs of a GNN. For example, this can be used to predict molecular sub-types of cancer, such as HER2 positivity, directly from tissue sample images by predicting the expression of a particular gene. This diagnosis informs patient treatment and medical decision-making.

The healthcare facility may include one or more medical professionals 502 who review information extracted from a patient's medical records 506 to determine their healthcare and treatment needs. These medical records 506 may include self-reported information from the patient, test results, and notes by healthcare personnel made to the patient's file. Treatment systems 504 may furthermore monitor patient status to generate medical records 506 and may be designed to automatically administer and adjust treatments as needed.

Based on information drawn from the spatial gene expression prediction and analysis 508, the medical professionals 502 may then make medical decisions about patient healthcare suited to the patient's needs. For example, the medical professionals 502 may make a diagnosis of the patient's health condition and may prescribe particular medications, surgeries, and/or therapies.

The different elements of the healthcare facility 500 may communicate with one another via a network 510, for example using any appropriate wired or wireless communications protocol and medium. Thus spatial gene expression prediction and analysis 508 receives information about a tissue sample from medical professionals 502, from treatment systems 504, from medical records 506, and updates the medical records 506 with the output of the GNN model. The spatial gene expression prediction and analysis 508 may coordinate with treatment systems 504 in some cases to automatically administer or alter a treatment. For example, if the spatial gene expression prediction and analysis 508 indicates a particular disease or condition, then the treatment systems 504 may automatically halt the administration of the treatment.

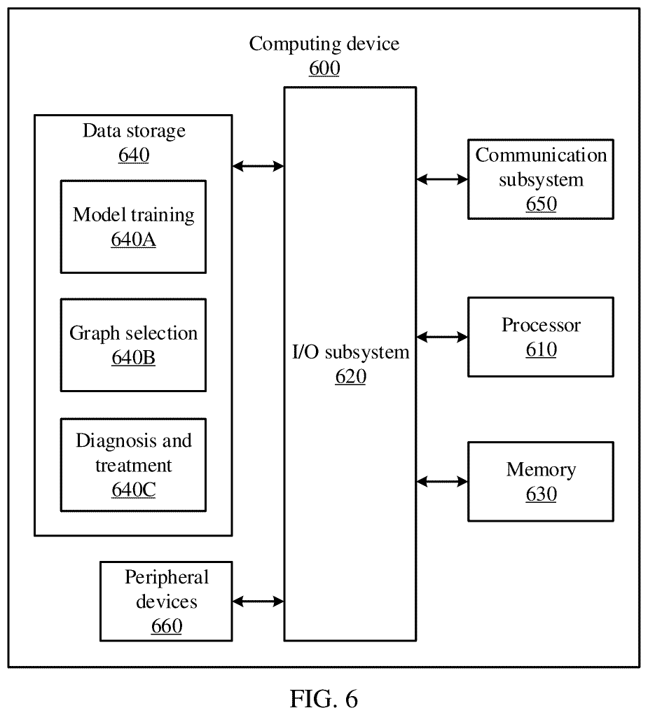

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for training a model, 640B for selecting a graph structure, and/or 640C for performing diagnosis and treatment. Any or all of these program code blocks may be included in a given computing system. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

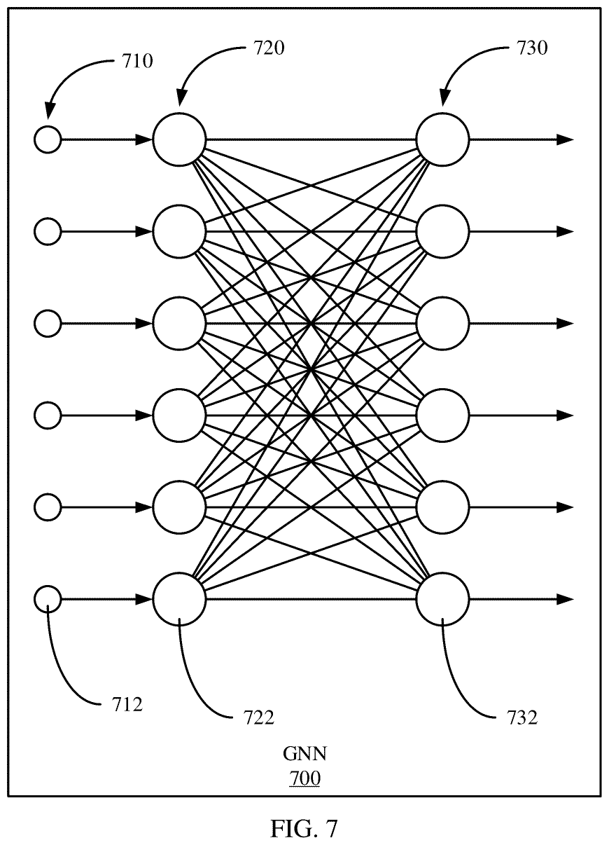

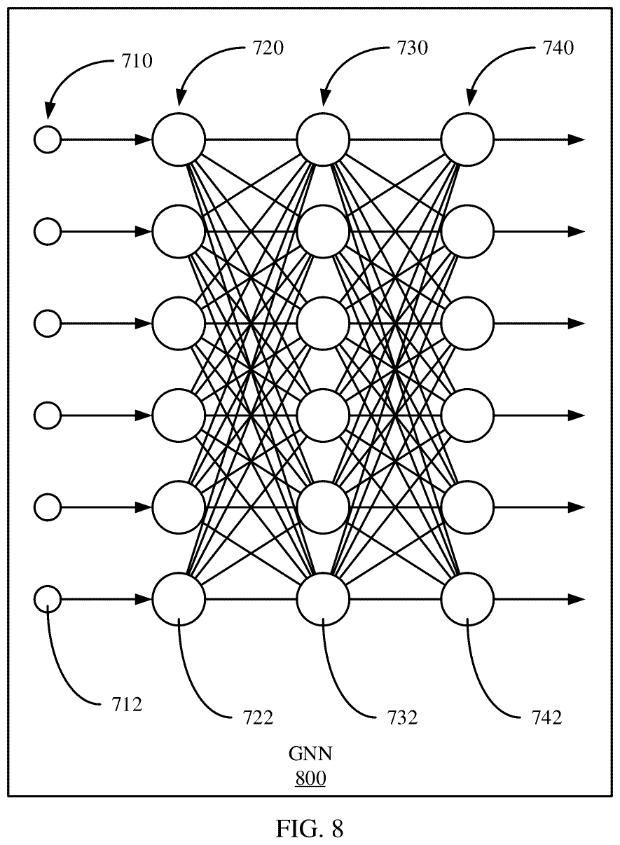

Referring now to FIGS. 7 and 8, exemplary neural network architectures are shown, which may be used to implement parts of the present models, such as the GNN 700/800. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 720 of source nodes 722, and a single computation layer 730 having one or more computation nodes 732 that also act as output nodes, where there is a single computation node 732 for each possible category into which the input example could be classified. An input layer 720 can have a number of source nodes 722 equal to the number of data values 712 in the input data 710. The data values 712 in the input data 710 can be represented as a column vector. Each computation node 732 in the computation layer 730 generates a linear combination of weighted values from the input data 710 fed into input nodes 720, and applies a non-linear activation function that is differentiable to the sum. The exemplary simple neural network can perform classification on linearly separable examples (e.g., patterns).

A deep neural network, such as a multilayer perceptron, can have an input layer 720 of source nodes 722, one or more computation layer(s) 730 having one or more computation nodes 732, and an output layer 740, where there is a single output node 742 for each possible category into which the input example could be classified. An input layer 720 can have a number of source nodes 722 equal to the number of data values 712 in the input data 710. The computation nodes 732 in the computation layer(s) 730 can also be referred to as hidden layers, because they are between the source nodes 722 and output node(s) 742 and are not directly observed. Each node 732, 742 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 732 in the one or more computation (hidden) layer(s) 730 perform a nonlinear transformation on the input data 712 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for graph analysis, comprising:
identifying trainable control parameters of a graph refinement function;
generating a plurality of sample graph refinements of an input graph, using control parameters sampled from a variational distribution;
selecting graph refinement control parameters associated with a sample of the plurality of sample graph refinements that has a highest performance score when used to train a graph neural network (GNN);
performing graph analysis on the input graph using the selected graph refinement parameters to produce a refined graph on new test samples; and
performing an action responsive to the graph analysis.

2. The method of claim 1, further comprising training the GNN and graph refinement parameters using the plurality of samples using smoothing-based optimization and local gradient descent.

3. The method of claim 2, wherein the performance score is a weighted average of a mean squared error and a Pearson correlation coefficient for a graph regression task.

4. The method of claim 1, wherein the input graph is a graph indicating a spatial proximity of capturing spots, with nodes that represent capturing spots and edges that represent spatial adjacency.

5. The method of claim 1, wherein the graph analysis includes predicting spatially resolved gene expression via tissue morphology in hematoxylin and eosin (H&E) stained images.

6. The method of claim 5, wherein the predicted spatially resolved gene expression relates to HER2 positivity and wherein the action includes a treatment for breast cancer.

7. The method of claim 1, wherein the graph neural network is a machine learning model that generates a prediction to aid in medical decision making.

8. The method of claim 1, wherein the action includes automatically altering a patient's treatment.

9. The method of claim 1, wherein the graph refinement function applies a threshold to linear projections of node features, using control parameters ϕ={σₚᵣₒⱼ, τ}: [symbol]
((X₀, E), ϕ)=(X₀, E′),
where E′ⱼ={(n₁, n₂)|(n₁, n₂) ∈Eᵢ, d (n₁, n₂)≤τ} and Zᵢ=X₀ϕₚᵣₒⱼ, and wherein message-passing on the GNN uses updates implemented as
$${x}_{n}^{l} = σ ( {\sum }_{\{ m \vert ( m , n ) ∈ {E}^{′} \}} \frac{{x}_{m}^{l - 1} {W}_{l}}{\sqrt{deg ( n ) deg ( m )}} )$$
for levels l<L, where l is a layer, L a number of layers in the GNN, m and n are nodes, E′ is a set of edges, Wₗ is weight matrix for the layer l, σ(x)=max (0, x) is a rectified linear unit (ReLU) function, and deg (·) is a degree of a node.

10. The method of claim 9, wherein generating the plurality of sample graph refinements includes sampling a Gaussian distribution with mean and standard deviation parameters that are iteratively determined by smoothing-based optimization.

11. A system for graph analysis, comprising:
a hardware processor; and
a memory that stores a computer program which, when executed by the hardware processor, causes the hardware processor to:
identify trainable control parameters of a graph refinement function;
generate a plurality of sample graph refinements of an input graph, using control parameters sampled from a variational distribution;
select graph refinement control parameters associated with a sample of the plurality of sample graph refinements that has a highest performance score when used to train a graph neural network (GNN);
perform graph analysis on the input graph using the selected graph refinement parameters to produce a refined graph on new test samples; and
perform an action responsive to the graph analysis.

12. The system of claim 11, wherein the computer program further causes the hardware processor to train the GNN and graph refinement control parameters using the plurality of samples using smoothing-based optimization and local gradient descent.

13. The system of claim 12, wherein the performance score is a weighted average of a mean squared error and a Pearson correlation coefficient for a graph regression task.

14. The system of claim 11, wherein the input graph is a graph indicating a spatial proximity of capturing spots, with nodes that represent capturing spots and edges that represent spatial adjacency.

15. The system of claim 11, wherein the graph analysis includes prediction of spatially resolved gene expression via tissue morphology in hematoxylin and eosin (H&E) stained images.

16. The system of claim 15, wherein the predicted spatially resolved gene expression relates to HER2 positivity and wherein the action includes a treatment for breast cancer.

17. The system of claim 11, wherein the graph neural network is a machine learning model that generates a prediction to aid in medical decision making.

18. The system of claim 11, wherein the action includes automatically alteration of a patient's treatment.

19. The system of claim 11, wherein the computer program further causes the hardware processor to apply a threshold to linear projections of node features, using control parameters ϕ={ϕₚᵣₒⱼ, τ}: [symbol]
((X₀, E), ϕ)=(X₀, E′),
where E′ᵢ={(n₁, n₂)|(n₁, n₂) ∈ Eᵢ, d (n₁, n₂)≤τ} and Zᵢ=X₀ϕₚᵣₒⱼ, and wherein message-passing on the GNN uses updates implemented as
$${x}_{n}^{l} = σ ( {\sum }_{\{ m \vert ( m , n ) ∈ {E}^{′} \}} \frac{{x}_{m}^{l - 1} {W}_{l}}{\sqrt{deg ( n ) deg ( m )}} )$$
for levels l<L, where l is a layer, L a number of layers in the GNN, m and n are nodes, E′ is a set of edges, Wₗ is weight matrix for the layer l, σ(x)=max (0, x) is a rectified linear unit (ReLU) function, and deg (·) is a degree of a node.

20. The system of claim 19, wherein the generation of the plurality of sample graph refinements includes sampling of a Gaussian distribution with mean and standard deviation parameters that are iteratively determined by smoothing-based optimization.
